(19) United States
(12) Patent Application Publication
(10) Pub. No.: US 2019/0241747 A1
(43) Pub. Date: Aug. 8, 2019

(54) UV-CURABLE COMPOSITIONS AND METHODS RELATED THERETO

(71) Applicant: Evonik Corporation, Parsippany, NJ (US)

(72) Inventors: Jacob SHEVRIN, New York, NY (US); Sheba Bergman, Jersey City, NJ (US)

(73) Assignee: Evonik Corporation, Parsippany, NJ (US)

(21) Appl. No.: 16/268,709

(22) Filed: Feb. 6, 2019

Related U.S. Application Data
(60) Provisional application No. 62/628,205, filed on Feb. 8, 2018.

(51) Int. Cl. C09D 4/06

(52) U.S. Cl. CPC C09D 4/06

(57) ABSTRACT

An unsaturated silane is used in methods and compositions for improving the gloss, matte and ultraviolet-curing efficiency properties of ultraviolet-curable compositions, adhesives and sealants.

### CROSS-REFERENCE TO RELATED APPLICATIONS

The present application claims priority to U.S. application 62/628,205, filed Feb. 8, 2018, the content of which is incorporated by reference in its entirety.

### FIELD OF THE INVENTION

The present disclosure relates generally to methods and compositions for improving the gloss, matte and ultraviolet-curing efficiency properties of ultraviolet-curable coatings, adhesives and sealants comprising the use of an unsaturated silane.

### BACKGROUND OF THE INVENTION

Ultraviolet curing (UV-curing) technology used for cross-linking coatings, inks, adhesives, sealants, etc. is a widely adopted technology used in many industries, including plastic, wood, metal, glass, automotive, telecommunications, electronics and graphic arts industries. In particular, water-borne and high solid, UV-curable technology offers many advantages including its increased efficiency and productivity, improved product quality and performance as well as favorable environmental characteristics (allowing for low or no volatile organic compound (VOC) in the formulation) over traditional drying methods such as water and solvent-based thermal drying methods and solvent-borne, UV curing methods. For example, a standard wood coating may take several days to fully cure at room temperature while a UV-curable wood coating may be fully cured in several hours with the proper curing equipment. UV-curable wood coatings have also been shown to achieve lower viscosity coatings than solvent-borne, UV-curable coatings. This is a crucial characteristic of wood coatings for indoor and outdoor wood applications. Furthermore, UV-curable coating technology does not require subjecting the coating formulations to elevated temperatures for prolonged periods of time to fully cure. These reductions in the curing times and energy costs for UV-curable coatings is a major reason for the widespread and growing interest in these coating technologies. As governmental regulations on coatings containing volatile organic compounds (VOCs) continues to become more restrictive on a global level, the presence of water-borne or high solid, UV-curable coatings is expected to thrive.

The extent of UV dosage required depends on several factors, including the amount of energy dissipated by the UV lamp and the time of exposure. The use of coating additives can further increase the efficiency of these coating applications, which is an ongoing research topic in the UV-curable coatings industry. The current invention seeks to further improve the UV-curing efficiency of UV-curable formulations which will reduce the amount of UV light dosage required for curing as well as enhance the gloss and matte properties of such formulations.

### SUMMARY OF THE INVENTION

In one aspect, the invention provides Composition I comprising:
(I) a silane of Formula I:

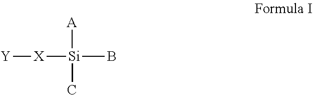

wherein:
   i) Y is a functional group capable of reacting under ultraviolet irradiation in the presence of a photoinitiator, e.g., Y is a vinyl, phenyl, acrylic or methacrylic group; or
      Y is a saturated functional group capable of coupling with radicals, e.g., Y is a thio group;
   ii) X is —C₁₋₆₀ alkyl, preferably —C₃₋₁₀ alkyl, preferably propyl, preferably n-propyl;
   iii) A and B are independently selected from:
      —X—Y wherein X and Y are as defined in (i) and (ii) above;
      —C₁₋₂₀ alkyl, preferably —C₁₋₃ alkyl, preferably methyl; and
      —OR¹ wherein R¹ is selected from the group consisting of H and —C₁₋₆ alkyl, preferably —C₁₋₃ alkyl, preferably OR¹ is methoxy or ethoxy;
   iv) C is —OR¹ wherein R¹ is selected from the group consisting of H and —C₁₋₆ alkyl, preferably —C₁₋₃ alkyl, preferably —OR¹ is methoxy or ethoxy;
(II) a photo initiator; and
(III) ultraviolet-curable resin.

In another embodiment, the invention provides Composition I according to the following formulae:
1.1 Composition I, wherein Y is a functional group capable of reacting under ultraviolet irradiation in the presence of a photoinitiator or a saturated functional group capable of coupling with radicals; e.g., Y is a vinyl, phenyl, acrylic, methacrylic or thio group;
1.2 Composition I, wherein Y is an acrylic or methacrylic group;
1.3 Composition I, wherein Y is an acrylic group;
1.4 Composition I, wherein Y is a methacrylic group;
1.5 Composition I, or any of formulae 1.1-1.4, Wherein X is —C₁₋₆₀ alkyl;
1.6 Composition I, or any of formulae 1.1-1.4, wherein X is —C₃₋₁₀ alkyl;
1.7 Composition I, or any of formulae 1.1-1.4, wherein X is propyl;
1.8 Composition I, or any of formulae 1.1-1.4, wherein X is n-propyl;
1.9 Composition I, or any of formulae 1.1-1.8, wherein A and B are independently selected from:
   —X—Y as defined in any of formulae 1.1-1.8;
   —C₁₋₂₀ alkyl, preferably —C₁₋₃ alkyl, preferably methyl; and
   —OR¹ wherein R¹ is selected from the group consisting of H and —C₁₋₆ alkyl, preferably —C₁₋₃ alkyl, preferably —OR¹ is methoxy or ethoxy
1.10 Composition I, or any of formulae 1.1-1.8, wherein A and B are independently —X—Y as defined in any of formulae 1.1-1.8;
1.11 Composition I, or any of formulae 1.1-1.8, wherein A and B are independently —C₁₋₂₀ alkyl,
1.12 Composition I, or any of formulae 1.1-1.8, wherein A and B are independently —C₁₋₃ alkyl;
1.13 Composition I, or any of formulae1.1-1.8, wherein A and B are independently methyl;
1.14 Composition I, or any of formulae 1.1-1.8, wherein A and B are independently —OR¹ wherein is selected from the group consisting of H and —C₁₋₆ alkyl, preferably —C₁₋₃ alkyl, preferably —OR¹ is methoxy or ethoxy;
1.15 Composition I, or any of formulae 1.1-1.8, wherein A and B are independently —OR¹ wherein R¹ is H;
1.16 Composition I, or any of formulae 1.1-1.8, wherein A and B are independently —OR¹ wherein R¹ is —C₁₋₆ alkyl;
1.17 Composition I, or any of formulae 1.1-1.8, wherein A and B are independently —OR¹ wherein R¹ is —C₁₋₃ alkyl;
1.18 Composition I, or any of formulae 1.1-1.8, wherein A and B are independently is methoxy;
1.19 Composition I, or any of formulae 1.1-1.8, wherein A and B are independently is ethoxy;
1.20 Composition I, or any of formulae 1.1-1.8, wherein A and B are the same;
1.21 Composition I, or any of formulae 1.1-1.20, wherein C is —OR¹ wherein R¹ is selected from the group consisting of H and —C₁₋₆ alkyl;
1.22 Composition I, or any of formulae 1,1-1.20, wherein C is —OR¹ wherein R¹ is H;
1.23 Composition I, or any of formulae 1.1-1.20, wherein C is —OR¹ wherein R¹ is alkyl;
1.24 Composition I, or any of formulae 1.1-1.20, wherein C is —OR¹ wherein R¹ is —C₁₋₃ alkyl;
1.25 Composition I, or any of formulae1.1-1.20, wherein C is —OR¹ wherein R¹ is methoxy;
1.26 Composition I, or any of formulae 1.1-1.20, wherein C is —OR¹ wherein R¹ is ethoxy;
1.27 Composition I, or any of formulae 1.1-1.26, wherein B and C are the same;
1.28 Composition I, wherein:
   i) Y is a vinyl, phenyl, acrylic, methacrylic or thio group, preferably methacrylic or acrylic group;
   ii) X is —C₁₋₆₀ alkyl, preferably —C₃₋₁₀ alkyl, preferably propyl, preferably n-propyl;
   iii) A is —C₁₋₂₀ alkyl, preferably —C₁₋₃ alkyl, preferably methyl and B is —OR¹ wherein R¹ is —C₁₋₆ alkyl, preferably —C₁₋₃ alkyl, preferably —OR¹ is methoxy or ethoxy; and
   iv) C is —OR¹ wherein R¹ is —C₁₋₆ alkyl, preferably —C₁₋₃ alkyl, preferably —OR¹ is methoxy or ethoxy;
1.29 Composition I, wherein:
   X is n-propyl;
   Y is any of formulae 1.1-1.4:
   A is methyl and B is —OR¹ wherein R¹ is any of formulae 1.16-1.20; and
   C is any of formulae 1.23-1.27
1.30 Formula 1.28 or 1.29, wherein Y is an acrylic group;
1.31 Formula 1.28 or 1.29, wherein Y is a methacrylic group
1.32 Composition I, wherein the silane of Formula I is selected from the group consisting of 3-methacryloxypropyl-trimethoxysilane (MEMO), 3-acryloxypropyl-trimethoxysilane (ACMO), 3-(triethoxysilyl)propyl methacrylate and 3-mercaptopropyltrimethoxysilane, preferably 3- methacryloxypropyl-trimethoxysilane or 3-acryloxypropyl-trimethoxysilane:
1.33 Composition I or any of formulae 1.1-1.32, wherein the silane of Formula I comprises by weight, about 0.3 wt. % to 10 wt. %, preferably, about 1-5 wt. % preferably about 1.5-3 wt. %, preferably about 2 wt. % of the total composition;
1.34 Composition I or any of formulae 1.1-1.33, wherein the photo-initiator comprises, by weight, about 0.3-5 wt. %, preferably about 0.5-3 wt. %, preferably about 1 wt. % of the total composition;
1.35 Composition I or any of formulae 1.1-1.34, wherein the ultraviolet-curable resin comprises, by weight, about 5-50 wt. %, preferably 20-40 wt. %, preferably about 30 wt. % of the total composition;
1.36 Composition I or any of formulae 1.1-1.34, wherein the ultraviolet-curable resin comprises, by weight, about 50-90 wt. %, preferably about 60-80 wt. %, preferably about 70-80 wt. %, preferably about 75 wt. % of the total composition.

In another aspect, the invention provides Composition I or any of Formulae 1.1-1.36 and a matting agent (Composition II). In a further embodiment, the matting agent of Composition II comprises by weight, about 0.5-2 wt. %, preferably, about 1 wt. % of the total composition.

The compositions of the current invention (e.g., Composition I or any of Formulae 1.1-1.36 and Composition II) may or may not contain a solvent. Therefore, in one embodiment, the compositions of the current invention is a high solids formulation, wherein said compositions comprise less than or equal to 10 wt. % solvent, in some instance, less than or equal to 5 wt. % solvent, in still another instance, no solvent (Composition I-A or II-A). Solvent useful for a high solid Composition I-A and II-A includes but is not limited to acrylic or methacrylic monomers. High solids Compositions I-A and II-A generally contain the ultraviolet-curable resin in an amount of about 50-90 wt. %, preferably about 60-80 wt. %, preferably about 70-80 wt. %, preferably about 75 wt. % of the total composition.

In another embodiment, the compositions of the current invention comprise a solvent in an amount greater than 10 wt. % of the total composition (Composition I-B or II-B). Solvent useful in Compositions I-B or II-B include water. Preferably, the solvent for such compositions is water (i.e., water-borne UV-curable compositions). Compositions I-B or II-B generally contain an ultraviolet-curable resin in an about of about 5-50 wt. %, preferably 20-40 wt. %, preferably about 30 wt. % of the total composition.

The compositions of the current invention (e.g., Composition I or any of Formulae 1.1-1.36 or Composition II) may further comprise additives including without limitation compounds and materials which are used for adjusting physical, rheological and chemical parameters of the compositions of the invention such as the viscosity (e.g. solvents, thickeners and thoxitropic agents), the consistency (e.g. surfactants, dispersants, anti-settling agents, fillers and plasticizers), the foaming properties (e.g. antifoaming agents), the lubricating properties (e.g. waxes), UV stability (photostabilizers) appearance (e.g. pigments, dyes, matting agents, leveling agents) and adhesion properties (e.g. wetting agents), etc. In a particular embodiment, the compositions of the current invention may further comprise one or more agent selected from the group consisting of an anti-foaming agent, a dispersant, a wax dispersion, a rheological modifier and a solvent. Preferably, the compositions of the current invention is a water-home UV-curable composition wherein the solvent is water,

In still another aspect, the invention provides a method for curing a substrate, which method comprises the steps of: (i) applying Composition I-A or II-A of the current invention to the substrate; (ii) irradiating an effective amount of ultraviolet light to cure said substrate (Method I-A).

In another aspect, the invention provides a method for curing a substrate, which method comprises the steps of: (i) applying Composition I-B or II-B of the current invention to the substrate; (ii) drying the substrate, e.g., until the substrate is dry to the touch, e.g., for about 0-2 hours, preferably, air-dry for about 60 minutes; (iii) irradiating an effective amount of ultraviolet light to cure said substrate (Method I-B).

An effective amount of UV-light necessary to cure a substrate in Method I-A and I-B will depend on several factors including the amount of energy dissipated by the UV lamp, the thickness of the composition coating the substrate and the time of exposure, which are within the knowledge of one skilled in the art. In one embodiment, step (ii) of Method I of the current invention comprises irradiating the coated substrate at about 100-400 nm, preferably at about 320-400 nm, preferably at about 350-400 nm.

In yet another aspect, the invention provides a method for enhancing the curing efficiency of a UV-curable composition or the gloss property of a cured substrate comprising the steps of adding a silane of Formula I:

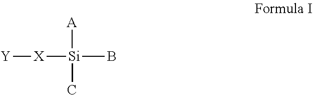

wherein:
i) Y is a functional group capable of reacting under ultraviolet irradiation in the presence of a photoinitiator, e.g., Y is a vinyl, phenyl, acrylic or methacrylic group; or
   Y is a saturated functional group capable of coupling radicals, e.g., Y is a thio group;
ii) X is —C₁₋₆₀ alkyl, preferably —C₃₋₁₀ alkyl, preferably propyl;
iii) A and B are independently selected from:
   —X—Y wherein X and Y are as defined in (i) and (ii) above:
   —C₁₋₂₀ alkyl, preferably —C₁₋₃ alkyl, preferably methyl; and
   —OR¹ wherein R¹ is selected from the group consisting of H and —C₁₋₆ alkyl, preferably —C₁₋₃ alkyl, preferably OR¹ is methoxy or ethoxy;
iv) C is —OR¹ wherein R¹ is selected from the group consisting of H and —C₁₋₆ alkyl, preferably C₁₋₃ alkyl, preferably —OR¹ is methoxy or ethoxy
   to a UV-curable composition (Method II). Silane of Method II may be as described e.g., in any of Formulae 1.1-1.33. The UV-curable composition of Method II comprises a photo-initiator and an ultraviolet-curable resin. In a further embodiment, the photo-initiator of Method II comprises, by weight, (a) about 0.3-5 wt. %, preferably about 0.5-3 wt. %, preferably about 1 wt. % of the total composition, and the ultraviolet-curable resin comprises, by weight, (b)(i) about 50-90 wt. %, preferably about 60-80 wt. %, preferably about 70-80 wt. %, preferably about 75 wt. % of the total composition; or (b)(ii) about 5-50 wt. %, preferably 20-40 wt. %, preferably about 30 wt. % of the total composition.

In yet another aspect, the invention provides a method for enhancing the matte property of a cured substrate comprising the steps of adding (a) a silane of Formula I

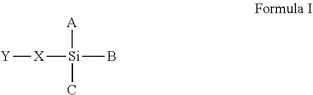

wherein:
i) Y is a functional group capable of reacting under ultraviolet irradiation in the presence of a photoinitiator, e.g., Y is a vinyl, phenyl, acrylic or methacrylic group; or
   Y is a saturated functional group capable of coupling with radicals, e.g., Y is a thio group;
ii) X is —C₁₋₆₀ alkyl, preferably —C₃₋₁₀ alkyl, preferably propyl;
iii) A and B are independently selected from:
   —X—Y wherein X and Y are as defined in (i) and (ii) above;
   —C₁₋₂₀ alkyl, preferably —C₋₃ alkyl, preferably methyl; and
   —OR¹ wherein R¹ is selected from the group consisting of H and —C₁₋₆ alkyl, preferably —C₁₋₃ alkyl, preferably OR¹ is methoxy or ethoxy;
C is —OR¹ wherein R¹ is selected from the group consisting of H and —C₁₋₆ alkyl, preferably —C₁₋₃ alkyl, preferably —OR¹ is methoxy or ethoxy;
   and (b) a matting agent, to a UV-curable composition (Method III). Silane of Method III may be as described e.g., in any of Formulae 1.1-1.33. The UV-curable composition of Method III comprises a photo-initiator and an ultraviolet-curable resin. In a further embodiment, the photo-initiator of Method Ill comprises, by weight, (a) about 0.3-5 wt. %, preferably about 0.5-3 wt. %, preferably about 1 wt. % of the total composition, and the ultraviolet-curable resin comprises, by weight, (b)(i) about 50-90 wt. %, preferably about 60-80 wt. %, preferably about 70-80 wt. % preferably about 75 wt. % of the total composition; or (b)(ii) about 5-50 wt. %. preferably 20-40 wt. %, preferably about 30 wt. % of the total composition. In yet another further embodiment, the matting agent of Method III comprises by weight, about 0.5-2 wt. , preferably, about 1 wt. % of the total composition.

### DETAILED DESCRIPTION OF THE INVENTION

Disclosed herein are compositions and methods for improving the gloss or matte properties of a cured substrate and the UV-curing efficiency of a UV-curable composition on a substrate. While it is known that UV-curing technology is more efficient at curing a substrate (e.g., cures faster) compared to other non-UV-curing techniques such as thermal curing, the current invention seeks to further enhance the curing time of a UV-curable composition on a substrate by incorporating an unsaturated silane, silane according to Formula I or any of Formulae 1.1-1.36 to a UV-curable composition. It is believed that the unsaturated silane can undergo radical polymerization upon exposure to UV light, thereby enhancing the efficiency of the UV curing process. As will be apparent from the examples herein, the Compositions of the current invention improves the curing efficiency of a substrate by about 25-33% compared to curing of a substrate coated with compositions without the silane of Formula I. The Compositions of the current invention also improves the gloss property of a cured substrate compared to substrates coated with compositions in the absence of a silane of Formula I. Further, the current invention also seeks to improve the matte property of a cured substrate by incorporating the silane of Formula I along with a matting agent in a composition described herein.

### Definition of Terms

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

The term “wt. %” means weight percent.

The term “photo-initiator” or “photoinitiator” means any agent which directly or indirectly produces initiator radicals, e.g., to initiate radical polymerization of the UV-curable resin to the substrate. Many photo-initiators are commercially available in the art. Photo-initiator useful for the methods and compositions of the current invention includes, but is not limited aromatic ketones (e.g., benzophenone), alkyl benzoin ethers, thioxanthone and derivatives, benzil ketals 2,2-dimethoxy 2-phenyl acetophenone (OMPA), acyl phosphine oxide (e.g., mono-acyl phosphine or his acylphosphine oxides), acetophenone and chlorinated acetophenone derivatives (e.g., diethoxy acetophenone or di- or tri-chloroacetophenone). Preferably, the photo-initiator useful in the methods and compositions of the current invention is trimethylbenzoyl-diphenyl-phosphine oxide or 1-hydroxycyclohexyl phenyl ketone or combination thereof.

In particular, water borne UV-curable coating composition contains a photoinitiator which can generate a radical species upon irradiation at an appropriate wavelength. The generated radical species will induce the polymerization of the main coating resin, which contains functionalities (e.g. acrylic, allyl ether, epoxy) that can participate in radical polymerization reactions. Among photoinitiators suitable for use in the present invention are alpha-cleavage type photoinitiators (type I) and hydrogen abstraction-type photoinitiators (type II). The photoinitiator may include other agents such as a coinitiator or photoinitiator synergist that aid the photochemical initiation reaction. Suitable alpha-cleavage type photoinitiators include, but are not limited to, alpha,alpha-diethoxyacetophenone (DEAP), dimethoxyphenylacetophenone (DMPA), 1-hydroxy-cyclohexylphenyl ketone (commercially available under the trade designation OMNIRAD 481 from IGM resins), 2-hydroxy-2-methyl-1-phenylpropan-1-one, bis-(2,6-dimethoxybenzoyl)-2,4,4-trimethylpentyl phosphine oxide, 2,4,6-trimethylbenzoyl-diphenylphosphine oxide (TPO), 2,4,6-trimethyl benzoylphosphine oxide, and mixtures thereof. Useful hydrogen abstraction-type photoinitiators include benzophenone, substituted benzophenones (such as that commercially available under the trade designation ESCACURE TZT from IGM resins), and other diaryl ketones such as xanthones, thioxanthones, Michler's ketone, benzil, quinones, and substituted derivatives of all of the above. A particularly preferred initiator mixture is commercially available under the trade designation OMINIRAD 4265 from IGM resins, which is a mixture of an alpha-cleavage type photoinitiator and a hydrogen abstraction-type photoinitiator, particularly 2,4,6-trimethylbenzoyl-diphenyl-phosphine oxide and 1-hydroxycyclohexyl-phenyl ketone in a 1:1 ratio. Other mixtures of photoinitiators may also be used in the compositions and methods of the present invention. Carnphorquinone is one example of a useful photoinitiator for curing a coating composition with visible light.

Ultraviolet-curable resin or UV-curable resin useful for the methods and compositions of the current invention includes, but is not limited to unsaturated polyester/acrylated polyester, acrylated epoxy resin (methacrylate), acrylated urethanes (such as the commercially available V-4263 commercially available from DIC), acrylated urethane polyester hybrids (such as the commercially available BR-441B, BR-741 and BR-742S from Dymax acrylated silicone resins, acrylated polyethers, acrylated urethane polyether hybrids (such as the commercially available BR-144B, BR-302 and BR-344 from Dymax), acrylated melamines, acrylate oils, N-vinyl urethanes, thiolene system. Preferably, UV-curable resin useful for the methods and compositions of the current invention is an acrylated polyurethane resin or an acrylated polyester/polyurethane hybrid resin, preferably as a water-borne dispersion or emulsion. Examples of an acrylated polyester/polyurethane hybrid resin that is dispersed in water include the commercially available LUX 250 resin from Alberdnigk-Boley. Examples of an acrylated polyurethane resins that are dispersed in water include the commercially available LUX 481 resin from Alberdnigk-Boley, the commercially available UCECOAT® 2501 from Annex Industries, and the commercially available NeoRad™ R-465 and R-514 XP from DSM.

The compositions disclosed herein may include a surface-active agent that modifies the interaction of the curable coating composition with the substrate. In particular, the agent can modify the ability of the composition to wet a substrate. Surface active agents may have other properties as well. For example, surface active agents may also include leveling, defoaming, or flow agents, and the like. The surface active agent affects qualities of the curable compositions disclosed herein including how the composition is handled, how it spreads across the surface of the substrate, and how it bonds to the substrate. If it is used, the surface active agent is preferably present in an amount of no greater than 5 wt %, based on the total weight of the compositions disclosed herein. Surface active agents have also been found to assist incorporation as well as assist compositions disclosed herein. Surface active agents suitable for use in compositions disclosed herein are known to those of skilled in the art or can be determined using standard methods. Examples of surface active agents include polydimethylsiloxane surface active agents (such as the commercially available BYK 346 from Byk-Chemie, and TEGO Wet 280, DYNOL 607 and DYNOL 604 from Evonik Corporation). The surface active agents may further include a defoamer. Useful defoamers include polysiloxane defoamers (such as a methylalkylpolysiloxane like that commercially available under the trade designation BYK 077 or BYK 500 from Byk-Chemie) or polymeric defoamers (such as those commercially available under the trade designation BYK 051 from Byk-Chemie), ether-modified polysiloxane-based defoamer available under the trade designation Surfynol DF-62, Tego Airex-904W, TEGO FOAMEX 822 and TEGO FOAMEX 815 N from Evonik Corporation.

Anti-foaming agent useful for the methods and compositions disclosed herein includes but is not limited to those commercially available in the art, such as polyether siloxane copolymer. Preferably, the anti-foaming agent is present in the methods and compositions disclosed herein in an amount by weight, of about 0.1-2 wt. %, preferably about 1 wt. % of the total composition.

Dispersant useful for the methods and compositions disclosed herein includes but is not limited to those commercially available in the art, such as aqueous copolymer solution, e.g., in an amount of about 0.1-1.5 wt. %, preferably about 0.2-1 wt. %, preferably about 0.5 wt. % of the total composition. Examples include, but are not limited to, the commercially available TEGO Dispers 747 W and TEGO Dispers 757 W from Evonik Corporation.

Wax dispersion useful for the methods and compositions disclosed herein includes but is not limited to those commercially available in the art, such as aqueous high density polyethylene wax dispersion, e.g., in an amount of about 0.5-5 wt. %, preferably about 1-4 wt. %, preferably about 3 wt. % of the total composition, Examples include, but are not limited to, the commercially available Ultra lube D-816 from Keim Additec.

The compositions disclosed herein also contain a rheology modifier or a thixotropic agent, which in this application refers to compounds that interact with each other or with other components in the compositions disclosed herein to form a thixotropic structure. The term thixotropic structure refers to materials that form a gel-like structure in the liquid phase resulting in a high viscosity in a resting state that shear thin (liquefy and flow freely) when sheer stress is applied to the material (e.g. mechanical agitation, smearing on a surface, passing through a spray nozzle), but return to their original gel-like high viscosity state when the sheer stress is removed. The thixotropic agent acts as a stabilizer and/or dispersing aid to enhance and/or maintain suspension of particles in the compositions disclosed herein such as the matting agents, pigment particles and the like. The thixotropic agents may be used alone, or may be combined with other rheology control agents (for example, waxes, thickeners and the like) to provide enhanced dispersibility in a selected compositions disclosed herein. The thixotropic agents can prevent the composition from hard settling, in which the components of the compositions disclosed herein form a hard cake on the bottom of the storage container. In some embodiments, the compositions disclosed herein is storage stable, which in this application means that the composition does not form a hard cake when stored at room temperature for at least one month, preferably at least three months, and even more preferably at least six months

Rheological modifier useful for the methods and compositions disclosed herein includes but is not limited to those commercially available in the art, such as polyurethane polymer, e.g., in water/butoxy triglycol, e.g., in an amount of about 0.1-1 wt. %, preferably 0.5 wt. % of the total composition. For example, the commercially available Rheovis PU 1214 from BASF. Other examples of theological modifiers include fumed silica, with or without surface treatment, such as the commercially available AEROSIL® R 972 (surface treated) and AEROSIL® 200 (untreated) from Evonik Corporation.

Matting agent useful for the methods and compositions disclosed herein includes but is not limited to those commercially available in the art, such as a silica-based matting agent, e.g., ACEMATT products from Evonik Corporation. Examples include ACEMATT 3300, ACEMATT 3600 and ACEMATT TS 100.

The compositions disclosed herein may be opaque, colored, pigmented, or transparent (no pigment). Useful pigments in the compositions disclosed herein include titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, and/or organic yellows (such as Hansa yellow). Also included are IR reflective pigments Shepherd yellows, Shepherd blacks, Shepherd blues, and Shepherd greens (Shepherd Color Co., Cincinnati, Ohio). Also included are metallic and effect pigments (e.g. mica). The compositions disclosed herein may also optionally include a gloss control additive or an optical brightener, such as, for example, those commercially available under the trade designation ACEMATT from Evonik Corporation.

In certain embodiments it is advantageous to include fillers or inert ingredients in the compositions disclosed herein and methods of the current invention. Fillers and inert ingredients include, for example, clay, glass beads, calcium carbonate, talc, silicas, organic fillers, and the like. Fillers extend, lower the cost of, alter the appearance of, or provide desirable characteristics to the composition before and after curing. Useful fillers are known to those of skill in the art or can be determined using standard methods. Fillers or inert ingredients are preferably present in an amount of about 0.1 wt % to about 40 wt %, based on the total weight of the composition.

The compositions disclosed herein may also include other ingredients that modify properties of the curable compositions disclosed herein as it is stored, handled, or applied, and at other or subsequent stages. Waxes, flatting agents, and other similar performance enhancing additives may be employed in this invention as required in amounts effective to upgrade the performance of the cured coating and the compositions. Desirable performance characteristics of the compositions disclosed herein include chemical resistance, abrasion resistance, hardness, gloss, reflectivity, appearance, or combinations of these characteristics, and other similar characteristics.

Certain compositions disclosed herein may also include one or more performance enhancing additives. Typical performance enhancing additives that may be employed include thickeners, heat stabilizers, leveling agents, anti-cratering agents, curing indicators, plasticizers, sedimentation inhibitors, ultraviolet-light absorbers, and the like to modify properties. Other components of the compositions disclosed herein include those typically used in paint formulations, such as biocides, anti-mold agents, surfactants, dispersants, defoamers, and the like.

The compositions disclosed herein can be applied using techniques including spray coating, brush coating, curtain coating, direct or differential roll coating applications, or the surface to be coated can be impregnated with the coating composition by immersion in a bath containing the coating composition. Spray application can be conventional air, air assist airless, airless, HVLP and the like, and also electrostatic disk, bells, and the like.

The compositions disclosed herein can be applied to a substrate such as a wood surface, a vinyl surface, a tile surface, a rubber modified cement surface, a marble surface, a metal surface, a plastic surface, or the surface of a laminated wall covering, flooring, or piece of furniture, and the like.

### EXAMPLES

The foregoing may be better understood by reference to the following examples, which are presented for purposes of illustration and are not intended to limit the scope of the invention.

### Example 1

A: Silyl Methacrylate Containing Gloss Composition

Approximately 75 wt % of a water-home polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-home, UV-curable composition. After adding in ˜1 wt. % of an anti-foaming agent (for example, TEGO FOAMEX 822 from Evonik, which is a thixotropic liquid emulsion of a fumed silica-containing polyether siloxane copolymer) and thinning the viscous resin down with ˜16 wt. % deionized water, ˜0.5 wt % of a dispersant (for example, TEGO Disperse 747-W from Evonik, which is an aqueous copolymer solution containing groups of high pigment affinity) and ˜3 wt. % of a wax dispersion (for example. Ultralube D-816 from Keim Additec, which is a water-based wax dispersion) are incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of ˜0.5 wt. % of a rheological modifier (for example, Rheovis PU 1214 from BASF, which is anon-ionic, polyurethane-based rheology additive) to thicken the composition. ˜2 wt. % of 3-methacryloxypropyl-trimethoxysilane is then added into the coating composition after the coating is thickened with the rheological modifier.

### Example 1-B

### Silyl Acrylate Containing Gloss Composition

Approximately 75 wt. % of a water-borne polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-home, UV-curable composition. After adding in ˜1 wt. % of an anti-foaming agent (for example, TEGO FOAMEX 822 from Evonik, which is a thixotropic liquid emulsion of a fumed silica-containing polyether siloxane copolymer) and thinning the viscous resin down with ˜16 wt. % deionized water, ˜0.5 wt. % of a dispersant (for example, TEGO Disperse 747-W from Evonik, which is an aqueous copolymer solution containing groups of high pigment affinity) and ˜3 wt. % of a wax dispersion (for example, Ultralube D-816 from Keim Additec, which is a water-based wax dispersion) are incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of ˜0.5 wt. % of a rheological modifier (for example, Rheovis PU 1214 from BASF, which is a non-ionic, polyurethane-based rheology additive) to thicken the composition. ˜2 wt. % of 3-acryloxypropyl-trimethoxysilane is then added into the coating composition after the coating is thickened with the rheological modifier.

### Example 1-C

### Control Gloss Composition

Approximately 75 wt. % of a water-borne polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-borne, UV-curable composition. After adding in ˜1 wt. % of an anti-foaming agent (for example, TEGO FOAMEX 822 from Evonik, which is a thixotropic liquid emulsion of a fumed silica-containing polyether siloxane copolymer) and thinning the viscous resin down with ˜16 wt. % deionized water, ˜0.5 wt. % of a dispersant (for example, TEGO Disperse 747-W from Evonik, which is an aqueous copolymer solution containing groups of high pigment affinity) and ˜3 wt. % of a wax dispersion (for example, Ultralube D-816 from Keim Additec, which is a water-based wax dispersion) are incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of ˜0.5 wt. % of a rheological modifier (for example, Rheovis PU 1214 from BASF, which is a non-ionic, polyurethane-based rheology additive) to thicken the composition. Silane of Formula I is excluded in this control composition.

### Example 2-A

### Silyl Methacrylate Containing Matte Composition

Approximately 75 wt. % of a water-borne polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-borne, UV-curable composition. After adding in ˜1 wt. % of an anti-foaming agent (for example, TEGO FOAMEX 822 from Evonik, which is a thixotropic liquid emulsion of a fumed silica-containing polyether siloxane copolymer) and thinning the viscous resin down with ˜16 wt. % deionized water, ˜0.5 wt. % of a dispersant (for example, TEGO Disperse 747-W from Evonik, which is an aqueous copolymer solution containing groups of high pigment affinity) is added. At this step, ˜1 wt. % of a matting agent (for example, ACEMATT TS 100 from Evonik, which is an untreated thermal silica) is incorporated into the composition to boost the matte properties of the system. ˜3 wt. % of a wax dispersion (for example, Ultralube D-816 from Keim Additec, which is a water-based wax dispersion) is then incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of 0.5 wt. % of a theological modifier (for example, Rheovis PU 1214 from BASF, which is a non-ionic, polyurethane-based rheology additive) to thicken the composition. ˜2 wt. % of 3-methacryloxypropyl-trimethoxysilane is then added into the coating composition after the coating is thickened with the rheological modifier.

### Example 2-B

### Silyl Acrylate Containing Matte Composition

Approximately 75 wt. % of a water-borne polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-borne, UV-curable composition. After adding in ˜1 wt. % of an anti-foaming agent (for example, TEGO FOAMEX 822 from Evonik, which is a thixotropic liquid emulsion of a fumed silica-containing polyether siloxane copolymer) and thinning the viscous resin down with ˜16 wt. % deionized water, ˜0.5 wt. % of a dispersant (for example, TEGO Disperse 747-W from Evonik, which is an aqueous copolymer solution containing groups of high pigment affinity) is added. At this step, ˜1 wt. % of a matting agent (for example, ACEMATT TS 100 from Evonik, which is an untreated thermal silica) is incorporated into the composition to boost the matte properties of the system. ˜3 wt. % of a wax dispersion (for example, Ultralube D-816 from Keim Additec, which is a water-based wax dispersion) is then incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of ˜0.5 wt. % of a theological modifier (for example, Rheovis PU 1214 from BASF, which is a non-ionic, polyurethane-based rheology additive) to thicken the composition. ˜2 wt. % of 3-acryloxypropyl-trimethoxysilane is then added into the coating composition after the coating is thickened with the theological modifier.

### Example 2-C

### Matte Composition

Approximately 75 wt. % of a water-home polymer dispersion that can undergo radical polymerization in the presence of ultraviolet light (for example, UROTUF E-300-W-40 from Reichhold, which is a commercially available, 40% solid content, water-borne, urethane dispersion based on an anionic stabilized dispersion of an aliphatic urethane polymer) is used as a resin to formulate this water-home, UV-curable composition. After adding in ˜1 wt. % of an anti-foaming agent (for example, TEGO FO AMEX 822 from Evonik, which is a thixotropic liquid emulsion of a fumed silica-containing polyether siloxane copolymer) and thinning the viscous resin down with ˜16 wt. % deionized water, ˜0.5 wt. % of a dispersant (for example, TECO Disperse 747-W from Evonik, which is an aqueous copolymer solution containing groups of high pigment affinity) is added. At this step, ˜1 wt. % of a matting agent (for example, ACEMATT TS 100 from Evonik, which is an untreated thermal silica) is incorporated into the composition to boost the matte properties of the system. ˜3 wt. % of a wax dispersion (for example, Ultralube D-816 from Keim Additec, which is a water-based wax dispersion) is then incorporated into the composition to prevent any polymer aggregation. At this point in the formulation, ˜1 wt. % of a photoinitiator (for example, Omnirad 4265 from IGM Resins, which is a liquid curing agent used to initiate radical photo polymerization of unsaturated resins) is added in, followed by the dropwise addition of ˜0.5 wt. % of a theological modifier (for example, Rheovis PU 1214 from BASF, which is a non-ionic, polyurethane-based rheology additive) to thicken the composition. Silane of Formula I is excluded in this control composition.

### Example 3

### Enhancement of the UV Curing Efficiency

The compositions of Examples 1-A, 1-B, 1-C, 2-A, 2-B, and 2-C are applied on Leneta cards. Without drying, the coated substrates are immediately passed through a UV chamber (UV Heraeus Belt Instrument—D Lamp—UVA spectrum 350 nm-400 nm) at a specific belt-speed. The coating hardness is evaluated by scraping a pipette (Fisherbrand—Transfer Pipettes) horizontally across the coating surface. If the pipette scratched or cut the coating, the coating is reported as not fully cured. If the pipette does not visibly scratch or impact the coating, the coating is marked as cured. Although the previous curing procedure incorporates a 60 minute air-dry before UV-curing to allow film coalescence, this test requires a wet coating to evaluate the minimum UV dosage needed for curing.

Results: It is observed that the incorporation of 3-methacryloxypropyl-trimethoxysilane, 3-acryloxypropyl-trimethoxysilane into UV-curable composition(i.e., the compositions of Examples 1-A, 1-B, 1-C, 2-A, 2-B, and 2-C) shows that the efficiency of the curing process can be significantly improved as can be seen below in Table 1.

TABLE 1
Maximum belt speeds in the UV Heraeus instrument required to
cure the Composition of Examples 1-A, 1-B, 1-C, 2-A, 2-B, and 2-C

| | Maximum belt Speed to | Efficiency |
|---|---|---|
| Coating Composition | Cure (feet per minute) | Improvement |
| Example 1-A | 8 | +25% |
| Example 1-B | 9 | +33% |
| Example 1-C | 6 | — |
| Example 2-A | 8 | +25% |
| Example 2-B | 9 | +33% |
| Example 2-C | 6 | — |

### Example 4

### Enhancement of the Gloss or Matte Property

The compositions of Examples 1-A, 1-B, 2-A and 2-B are applied on Leneta cards. The coated substrates are left for 60 minutes at room temperature to air-dry before proceeding. The coated substrates are then passed through a UV chamber (UV Heraeus Belt instrument—D Lamp—UVA spectrum 350 nm-400 nm) one time at a belt speed of 14 feet per minute. After exposure to UV light, the compositions sat at room temperature for at least a few hours before any testing procedures were performed. After applying and properly curing the composition of Example 1-A, 1-B, 1-C, 2-A, 2-B, and 2-C on Leneta cards, gloss tests are performed with a Micro-tri-gloss meter (BYK-Gardener Instruments). Five gloss measurements are performed at different locations on each coated substrate, and the average gloss readings are reported in International Gloss Units at 20°, 60°, and 85°.

Results: It is observed that the incorporation of 3-methacryloxypropyl-trimethoxysilane, 3-acryloxypropyl-trimethoxysilane into UV-curable composition (i.e., the compositions of Examples 1-A, 1-B, 1-C, 2-A, 2-B, and 2-C) shows to have a significant impact on the final glossiness or matteness of the substrate coating as can be seen in Table 2 and Table 3 below:

TABLE 2
Gloss measurements (85°) of the Composition
of Examples 1-A, 1-B, 1-C after UV curing

| Coating Composition | Average Gloss Reading | Glossy Improvement |
|---|---|---|
| Example 1-A | 70 | +7% |
| Example 1-B | 75 | +13% |
| Example 1-C | 65 | — |

TABLE 3
Gloss measurements (20°) of the Composition
of Example 2-A, 2-B, 2-C after UV curing

| Coaling Composition | Average Gloss Reading | Glossy Improvement |
|---|---|---|
| Example 2-A | 3 | +40% |
| Example 2-B | 3 | +40% |
| Example 2-C | 5 | — |

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

### Exemplary Embodiments

For reasons of completeness, various aspects of the disclosure are set out in the following numbered clauses:

Clause 1. Composition I comprising:
(I) a silane of Formula I:

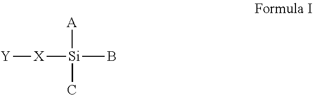

wherein:
   i) Y is a functional group capable of reacting under ultraviolet irradiation in the presence of a photoinitiator, e.g., Y is a vinyl, phenyl, acrylic or methacrylic group; or
      Y is a saturated functional group capable of coupling with radicals, e.g., Y is a thio group;
   ii) X is —C₁₋₆₀ alkyl, preferably —C₃₋₁₀ alkyl, preferably propyl, preferably n-propyl;
   iii) A and B are independently selected from:
      —X—Y wherein X and Y are as defined in (i) and (ii) above;
      —C₁₋₂₀ alkyl, preferably —C₁₋₃ alkyl, preferably methyl; and
      —OR¹ wherein R¹ is selected from the group consisting of H and —C₁₋₆ alkyl, preferably —C₁₋₃ alkyl, preferably —OR¹ is methoxy or ethoxy;
   iv) C is —OR¹ wherein R¹ is selected from the group consisting of H and —C₁₋₆ alkyl, preferably —C₁₋₃ alkyl, preferably —OR¹ is methoxy or ethoxy;
(II) a photo initiator; and
(III) ultraviolet-curable resin.

Clause 2. The composition of clause 1, wherein:
i) Y is a vinyl, phenyl, acrylic, methacrylic or thio group, preferably methacrylic or acrylic group;
ii) X is —C₁₋₆₀ alkyl, preferably —C₃₋₁₀ alkyl, preferably propyl, preferably n-propyl;
iii) A is —C₁₋₂₀ alkyl, preferably —C₁₋₃ alkyl, preferably methyl and B is —OR¹ wherein R¹ is —C₁₋₆ alkyl, preferably —C₁₋₃ alkyl, preferably —OR¹ is methoxy or ethoxy; and
iv) C is —OR¹ wherein R¹ is —C₁₋₆ alkyl, preferably —C₁₋₃ alkyl, preferably OR¹ is methoxy or ethoxy.

Clause 3. The composition of clause 1 or , wherein Y is an acrylic group.

Clause 4. The composition of clause 1 or 2, wherein Y is a methacrylic group.

Clause 5. The composition of clause 1 or 2, wherein the silane of Formula I is selected from the group consisting of 3-methacryloxypropyl-trimethoxysilane, 3-acryloxypropyl-trimethoxysilane, 3-(triethoxysilyl)propyl methacrylate and 3-mercaptopropyltrimethoxysilane.

Clause 6. The composition of clause 1 or 2, wherein the silane of Formula I is 3-acryloxypropyl-trimethoxysilane.

Clause 7. The composition of any of clauses 1-6, wherein the silane of Formula I comprises by weight, about 0.3 wt. % to 10 wt. %, preferably, about 1-5 wt. %, preferably about 1.5-3 wt. %, preferably about 2 wt % of the total composition.

Clause 8. The composition of any of clauses 1-7, wherein the photo-initiator comprises, by weight, about 0.3-5 wt. %, preferably about 0.5-3 wt. %, preferably about 1 wt. % of the total composition.

Clause 9. The composition of clause 8, wherein the photo-initiator is trimethylbenzoyl-diphenyl-phosphine oxide or hydroxycyclohexyl phenyl ketone or combination thereof.

Clause 10. The composition of any of clauses 1-9, wherein the ultraviolet-curable resin comprises, by weight, about 5-50 wt. %, preferably 20-40 wt. %, preferably about 30 wt. % of the total composition.

Clause 11. The composition of any of clauses 1-9, wherein the ultraviolet-curable resin comprises, by weight, about 50-90 wt. %, preferably about 60-80 wt. %, preferably about 70-80 wt. %, preferably about 75 wt. % of the total composition.

Clause 12. The composition of clause 10, wherein the ultraviolet-curable resin is a urethane resin, preferably water-home urethane dispersion.

Clause 13. The composition of any of clauses 1-12, further comprising a matting agent, preferably silica-based matting agent.

Clause 14. A method for enhancing the curing efficiency of a UV-curable composition or the gloss property of a cured substrate comprising the steps of adding a silane of Formula I:

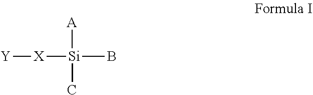

wherein:
i) Y is a functional group capable of reacting under ultraviolet irradiation in the presence of a photoinitiator, e.g., Y is a vinyl, phenyl, acrylic or methacrylic group; or
   Y is a saturated functional group capable of coupling with radicals, e.g., Y is a thio group;
ii) X is —C₁₋₆₀ alkyl, preferably —C₃₋₁₀ alkyl, preferably propyl;
iii) A and B are independently selected from:
   —X—Y wherein X and Y are as defined in (i) and (ii) above;
   —C₁₋₂₀ alkyl, preferably —C₁₋₃ alkyl, preferably methyl; and
   —OR¹ wherein R¹ is selected from the group consisting of H and —C₁₋₆ alkyl, preferably —C₁₋₃ alkyl, preferably —OR¹ is methoxy or ethoxy.
iv) C is —OR¹ wherein R¹ is selected from the group consisting of H and —C₁₋₆ alkyl, preferably —C₁₋₃ alkyl, preferably —OR¹ is methoxy or ethoxy;
   to a UV-curable composition.

Clause 15. The method of clause 14, wherein:
i) Y is a vinyl, phenyl, acrylic, methacrylic or thio group, preferably methacrylic or acrylic group;
ii) X is —C₁₋₆₀ alkyl, preferably —C₃₋₁₀ alkyl, preferably propyl, preferably n-propyl;
iii) A is —C₁₋₂₀ alkyl, preferably —C₁₋₃ alkyl, preferably methyl and B is —OR¹ wherein R¹ is —C₁₋₆ alkyl, preferably —C₁₋₃ alkyl, preferably —OR¹ is methoxy or ethoxy; and
C is —OR¹ wherein R¹ is —C₁₋₆ alkyl, preferably —C₁₋₃ alkyl, preferably OR¹ is methoxy or ethoxy.

Clause 16. The method of clause 14 or 15, wherein Y is an acrylic group.

Clause 17. The method of clause 14 or 15, wherein Y is a methacrylic group.

Clause 18. The method of clause 14 or 15, wherein the silane of Formula I is selected from the group consisting of 3-methacryloxypropyl-trimethoxysilane, 3-acryloxypropyl-trimethoxysilane, 3-(triethoxysilyl)propyl methacrylate and 3-mercaptopropyltrimethoxysilane.

Clause 19. The method of clause 14 or 15, wherein the silane of Formula 1 is 3-acryloxypropyl-trimethoxysilane.

Clause 20. The method of any of clauses 14-19, wherein the silane of Formula I comprises by weight, about 0.3 wt. % to 10 wt. %, preferably, about 1-5 wt. %, preferably about 1.5-3 wt. %, preferably about 2 wt. % of the total composition.

Clause 21. The method of any of clauses 14-20, wherein the UV-curable composition comprises a photo-initiator and an ultraviolet-curable resin.

Clause 22. The method of clause 21, wherein the photo-initiator comprises, by weight, about 0.3-5 wt. %, preferably about 0.5-3 wt. %, preferably about 1 wt. % of the total composition.

Clause 23. The method of clause 22, wherein the photo-initiator is trimethylbenzoyl-diphenyl-phosphine oxide or hydroxycyclohexyl phenyl ketone or combination thereof.

Clause 24. The method of any of clauses 21-23, wherein the ultraviolet-curable resin comprises, by weight, about 5-50 wt. %, preferably 20-40 wt. %, preferably about 30 wt. % of the total composition.

Clause 25. The method of any of clauses 21-23, wherein the ultraviolet-curable resin comprises, by weight, about 50-90 wt. %, preferably about 60-80 wt. %, preferably about 70-80 wt. %, preferably about 75 wt. % of the total composition.

Clause 26. The method of clause 24, wherein the ultraviolet-curable resin is a urethane resin, preferably water-home urethane dispersion.

Clause 27. A method for enhancing the matte property of a cured substrate comprising the steps of adding (a) a silane of Formula I

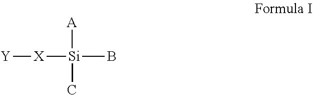

wherein:
i) Y is a functional group capable of reacting under ultraviolet irradiation in the presence of a photoinitiator, e.g., Y is a vinyl, phenyl, acrylic or methacrylic group; or
   Y is a saturated functional group capable of coupling radicals, e.g., Y is a thio group;
ii) X is —C₁₋₆₀ alkyl, preferably —C₃₋₁₀ alkyl, preferably propyl;
iii) A and B are independently selected from:
   —X—Y wherein X and Y are as defined in (i) and (ii) above;
   —C₁₋₂₀ alkyl, preferably —C₁₋₃ alkyl, preferably methyl; and
   —OR¹ wherein R¹ is selected from the group consisting of H and —C₁₋₆ alkyl, preferably —C₁₋₃ alkyl, preferably —OR¹ is methoxy or ethoxy;
   C is —OR¹ wherein R¹ is selected from the group consisting of H and —C₁₋₆ alkyl, preferably —C₁₋₃ alkyl, preferably —OR¹ is methoxy or ethoxy;
      and (b) a matting agent, to a UV-curable composition.

Clause 28. The method of clause 27, wherein the matting agent is silica-based matting agent.

What is claimed is:

1. A composition, comprising:
(I) a silane of Formula I: 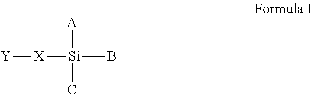
wherein:
i) Y is a functional group capable of reacting under ultraviolet irradiation in the presence of a photoinitiator; or
Y is a saturated functional group capable of coupling with radicals;
ii) X is —C₁₋₆₀ alkyl;
iii) A and B are independently selected from:
—X—Y wherein X and Y are as defined in (i) and (ii) above;
—C₁₋₂₀ alkyl; and
—OR¹ wherein R¹ is selected from the group consisting of H and —C₁₋₆ alkyl;
iv) C is —OR¹ wherein R¹ is selected from the group consisting of H and —C₁₋₆ alkyl;
(II) a photo initiator; and
(III) ultraviolet-curable resin.

2. The composition of claim 1, wherein:
i) Y is a vinyl, phenyl, acrylic, methacrylic or thio group;
ii) X is —C₁₋₆₀ alkyl;
iii) A is —C₁₋₂₀ alkyl and B is —OR¹ wherein R¹ is alkyl; and
iv) C is —OR¹ wherein R¹ is —C₁₋₆ alkyl.

3. The composition of claim 1, wherein Y is an acrylic group.

4. The composition of claim 1, wherein Y is a methacrylic group.

5. The composition of claim 1, wherein the silane of Formula I is selected from the group consisting of 3-methacryloxypropyl-trimethoxysilane, 3-acryloxypropyl-trimethoxysilane, 3-(triethoxysilyl)propyl methacrylate and 3-mercaptopropyltrimethoxysilane.

6. The composition of claim 1, wherein the silane of Formula I is 3-acryloxypropyl-trimethoxysilane.

7. The composition of claim 1, wherein the silane of Formula I comprises by weight, about 0.3 wt. % to 10 wt. % of the total composition.

8. The composition of claim 1, wherein the photo-initiator comprises, by weight, about 0.3-5 wt. % of the total composition.

9. The composition of claim 1, wherein the photo-initiator is trimethylbenzoyl-diphenyl-phosphine oxide, 1-hydroxycyclohexyl phenyl ketone or combination thereof.

10. The composition of claim 1, wherein the ultraviolet-curable resin comprises, by weight, about 5-50 wt. % of the total composition.

11. The composition of claim 1, wherein the ultraviolet-curable resin comprises, by weight, about 50-90 wt. % of the total composition.

12. The composition of claim 10, wherein the ultraviolet-curable resin is a urethane resin.

13. The composition of claim 1, further comprising a matting agent.

14. A method for enhancing the curing efficiency of a UV-curable composition or the gloss property of a cured substrate, said method comprising:
adding a silane of Formula I: 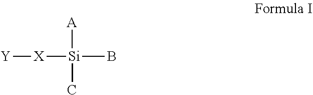
wherein:
v) Y is a functional group capable of reacting under ultraviolet irradiation in the presence of a photoinitiator; or
Y is a saturated functional group capable of coupling with radicals;
vi) X is —C₁₋₆₀ alkyl;
vii) A and B are independently selected from:
—X—Y as defined above;
—C₁₋₂₀ alkyl; and
—OR¹ wherein R¹ is selected from the group consisting of H, —C₁₋₆ alkyl;
viii) C is —OR¹ wherein R¹ is selected from the group consisting of H and —C₁₋₆ alkyl;
to a UV-curable composition.

15. The method of claim 14, wherein:
v) Y is a vinyl, phenyl, acrylic, methacrylic or thio group;
vi) X is —C₁₋₆₀ alkyl;
vii) A is —C₁₋₂₀ alkyl, and B is —OR¹ wherein is —C₁₋₆ alkyl; and
viii) C is —OR¹ wherein R¹ is —C₁₋₆ alkyl.

16. The method of claim 14, wherein Y is an acrylic group.

17. The method of claim 14, wherein Y is a methacrylic group.

18. The method of claim 14, wherein the silane of Formula I is selected from the group consisting of 3-methacryloxypropyl-trimethoxysilane, 3-acryloxypropyl-trimethoxysilane, 3-(triethoxysilyl)propyl methacrylate and 3-mercaptopropyltrimethoxysilane.

19. The method of claim 14, wherein the silane of Formula I is 3-acryloxypropyl-trimethoxysilane.

20. The method of claim 14, wherein the silane of Formula I comprises by weight, about 0.3 wt. % to 10 wt. % of the total composition.

21. The method of claim 14, wherein the UV-curable composition comprises a photo-initiator and an ultraviolet-curable resin.

22. The method of claim 21, wherein the photo-initiator comprises, by weight, about 0.3-5 wt. % of the total composition.

23. The method of claim 22, wherein the photo-initiator is trimethylbenzoyl-diphenyl-phosphine oxide or 1-hydroxycyclohexyl phenyl ketone or combination thereof.

24. The method of claim 21, wherein the ultraviolet-curable resin comprises, by weight, about 5-50 wt. % of the total composition.

25. The method of claim 21, wherein the ultraviolet-curable resin comprises, by weight, about 50-90 wt. % of the total composition.

26. The method of claim 24, wherein the ultraviolet-curable resin is a urethane resin.

27. A method for enhancing the matte property of a cured substrate, said method comprising:
adding (a) a silane of Formula I 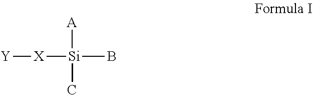
wherein:
iv) Y is a functional group capable of reacting under ultraviolet irradiation in the presence of a photoinitiator; or
Y is a saturated functional group capable of coupling with radicals;
v) X is C₁₋₆₀ alkyl;
vi) A and B are independently selected from:
—X—Y wherein X and Y are as defined in (i) and (ii) above:
—C₁₋₂₀ alkyl; and
—OR¹ wherein R¹ is selected from the group consisting of H and —C₁₋₆ alkyl;
C is —OR¹ wherein R¹ is selected from the group consisting of H and —C₁₋₆ alkyl;
and (b) a matting agent, to a UV-curable composition.

28. The method of claim 27, wherein the matting agent is silica-based matting agent.
